(19) United States
(12) Patent Application Publication
(10) Pub. No.: US 2009/0254918 A1
(43) Pub. Date: Oct. 8, 2009

(54) Mechanism for Performance Optimization of Hypertext Preprocessor (PHP) Page Processing Via Processor Pinning

(76) Inventors: Steven J. Branda, Rochester, MN (US); William T. Newport, Rochester, MN (US); John J. Stecher, Rochester, MN (US); Robert Wisniewski, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 12/061,757

(22) Filed: Apr. 3, 2008

(51) Int. Cl. G06F 9/46

(52) U.S. Cl. 718/105

(57) ABSTRACT

A method, system, and computer program product for optimizing “Hypertext Preprocessor” (PHP) processes by identifying the PHP pages which are active on a server and forwarding requests for specific pages to a processor which has recently processed that page. A request processing optimization (RPO) utility assigns an initial request received at the server for a PHP page based on a number of factors which may include a relative usage level of a processor within a pool of available processors on a server. The RPO utility assigns a request to additional processors based on: (1) a threshold frequency of page requests; and (2) a resource intensive factor of a page request measured by average response time of the page request. The assignment of PHP pages to a particular processor(s) enhances cache performance since the requisite code for a specific PHP page is loaded into the processor's cache.

### BACKGROUND

1. Technical Field

The present invention generally relates to data processing systems and in particular to the processing of Hypertext Preprocessor (PHP) requests in data processing (network) systems.

2. Description of the Related Art

PHP (“Hypertext Preprocessor”) is a widely used platform for dynamic web programming. Despite an open nature and de-centralized development model, PHP is used in many high capacity mission critical areas to solve major business problems. The model for PHP is somewhat unique in that for each incoming request, the PHP runtime initiates a new process to handle the processing of the request. This is a relatively complex operation for which resources are allocated and de-allocated each time a PHP request is received and processed. Unfortunately, this conventional method of processing PHP requests requires significant overhead.

### SUMMARY OF ILLUSTRATIVE EMBODIMENTS

Disclosed are a method, system, and computer program product for optimizing “Hypertext Preprocessor” (PHP) processes by identifying the PHP pages which are active on a server and forwarding requests for specific pages to a processor which has recently processed that page. A request processing optimization (RPO) utility assigns an initial request received at the server for a PHP page based on a number of factors which may include a relative usage level of a processor within a pool of available processors on a server. The RPO utility assigns a request to additional processors based on: (1) a threshold frequency of page requests; and (2) a resource intensive factor of a page request measured by average response time of the page request. The assignment of PHP pages to a particular processor(s) enhances cache performance since the requisite code for a specific PHP page is loaded into the processor's cache.

The above as well as additional objectives, features, and advantages of the present invention will become apparent in the following detailed written description.

### BRIEF DESCRIPTION OF THE DRAWINGS

The invention itself will best be understood by reference to the following detailed description of an illustrative embodiment when read in conjunction with the accompanying drawings, wherein:

FIG. 1 is a block diagram representation of a data processing system, according to one embodiment of the invention;

FIG. 2 illustrates a network, in which a client's request for PHP pages are processed by a server having multiple processors, in accordance with one embodiment of the invention;

FIG. 3 is a flow chart illustrating the process of identifying PHP pages which are active on a server and assigning requests for specific pages to multiple processors, in accordance with one embodiment of the invention.

### DETAILED DESCRIPTION OF AN ILLUSTRATIVE EMBODIMENT

The illustrative embodiments provide a method, system, and computer program product for optimizing “Hypertext Preprocessor” (PHP) processes by identifying the PHP pages which are active on a server and forwarding requests for specific pages to a processor which has recently processed that page. A request processing optimization (RPO) utility assigns an initial request received at the server for a PHP page based on a number of factors which may include a relative usage level of a processor within a pool of available processors on a server. The RPO utility assigns a request to additional processors based on: (1) a threshold frequency of page requests; and (2) a resource intensive factor of a page request measured by average response time of the page request. The assignment of PHP pages to a particular processor(s) enhances cache performance since the requisite code for a specific PHP page is loaded into the processor's cache.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

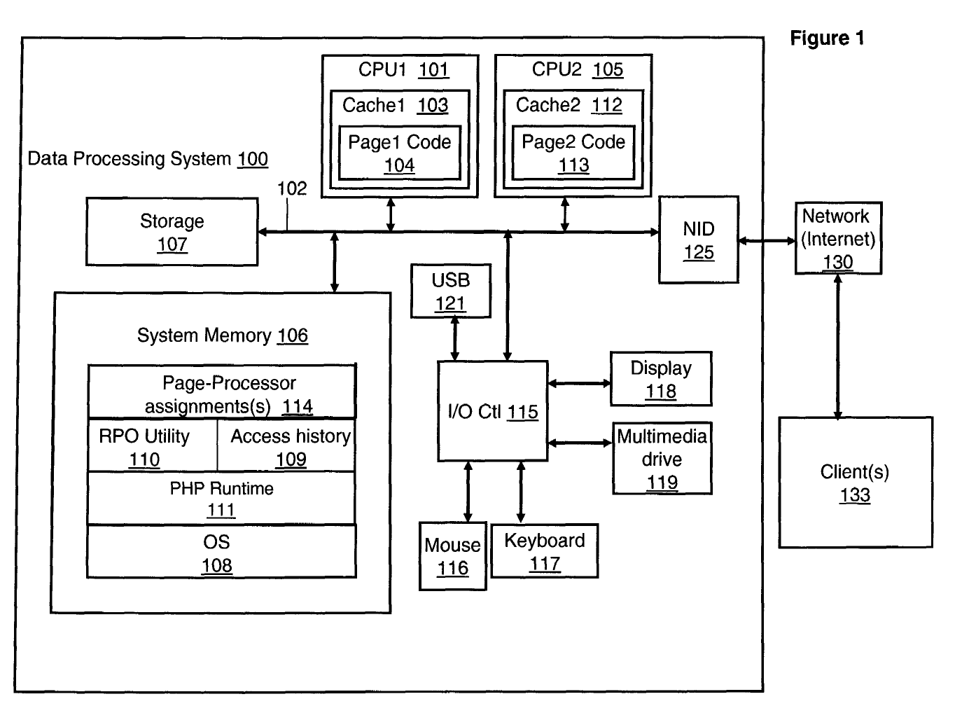

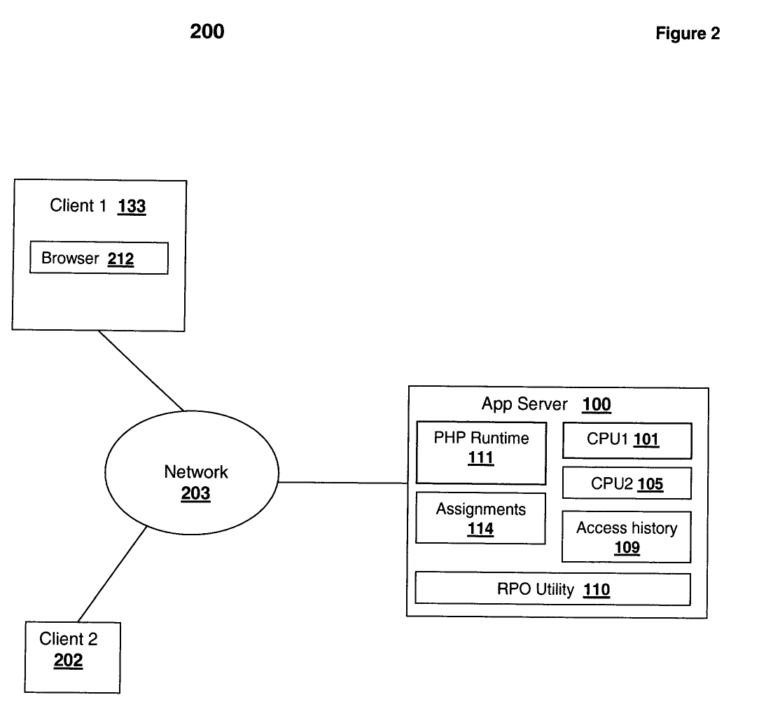

Within the descriptions of the figures, similar elements are provided similar names and reference numerals as those of the previous figure(s). Where a later figure utilizes the element in a different context or with different functionality, the element is provided a different leading numeral representative of the figure number (e.g, 1xx for FIG. 1 and 2xx for FIG. 2). The specific numerals assigned to the elements are provided solely to aid in the description and not meant to imply any limitations (structural or functional) on the invention.

It is understood that the use of specific component, device and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that term is utilized.

With reference now to FIG. 1, there is depicted a block diagram representation of a data processing system (DPS) (and connected network). DPS 100 comprises at least two processors or central processing units (CPUs), for example, CPU1 101 and CPU2 105 both connected to system memory 106 via system interconnect/bus 102. Illustrated within memory 106 is PHP runtime 111 which enables the execution of PHP code. CPU1 101 and CPU2 105 include level 1 (L1) caches, Cache1 103 and Cache2 112, respectively. Also connected to system bus 102 is I/O controller 115, which provides connectivity and control for input devices, of which pointing device (or mouse) 116 and keyboard 117 are illustrated, and output devices, of which display 118 is illustrated. Additionally, a multimedia drive 119 (e.g., CDRW or DVD drive) and USB (universal serial bus) hub 121 are illustrated, coupled to I/O controller. Multimedia drive 119 and USB hub 121 may operate as both input and output (storage) mechanisms. DPS 100 also comprises storage 107, within which data/instructions/code may be stored.

DPS 100 is also illustrated with a network interface device (NID) 125, with which DPS 100 connects to one or more clients 133 via access network 130, such as the Internet. In particular, DPS 100 may represent an application server which receives PHP page requests from client 133. In the described embodiments, network 130 is a worldwide collection of networks and gateways that utilize the Transmission Control Protocol/Internet Protocol (TCP/IP) suite of protocols to communicate with one another. Of course, network access may also be provided via a number of different types of networks, such as an intranet, a local area network (LAN), a virtual private network (VPN), or a wide area network (WAN) other than the Internet, for example.

Notably, in addition to the above described hardware components of DPS 100, various features of the invention are completed via software (or firmware) code or logic stored within memory 106, Cache1 103, Cache2 112, or other storage (e.g., storage 107) and executed by CPU1 101 and CPU2 105. Thus, illustrated within memory 106 are a number of software/firmware components, including operating system (OS) 108 (e.g., Microsoft Windows®, a trademark of Microsoft Corp, GNU®/Linux®, registered trademarks of the Free Software Foundation and Linus Torvalds, or AIX®, a registered trademark of IBM), page-processor assignments 114, access history 109 and request processing optimization (RPO) utility 110. Illustrated within Cache1 103 and Cache2 112 are Page1 Code 104 and Page2 Code 113, respectively. In actual implementation, page-processor assignments 114, access history 109 and RPO utility 110 may be combined as a single application collectively providing the various functions of each individual software component when the corresponding code is executed by CPU1 101 or CPU2 105. For simplicity, RPO utility 110 is illustrated and described as a stand alone or separate software/firmware component, which provides specific functions, as described below.

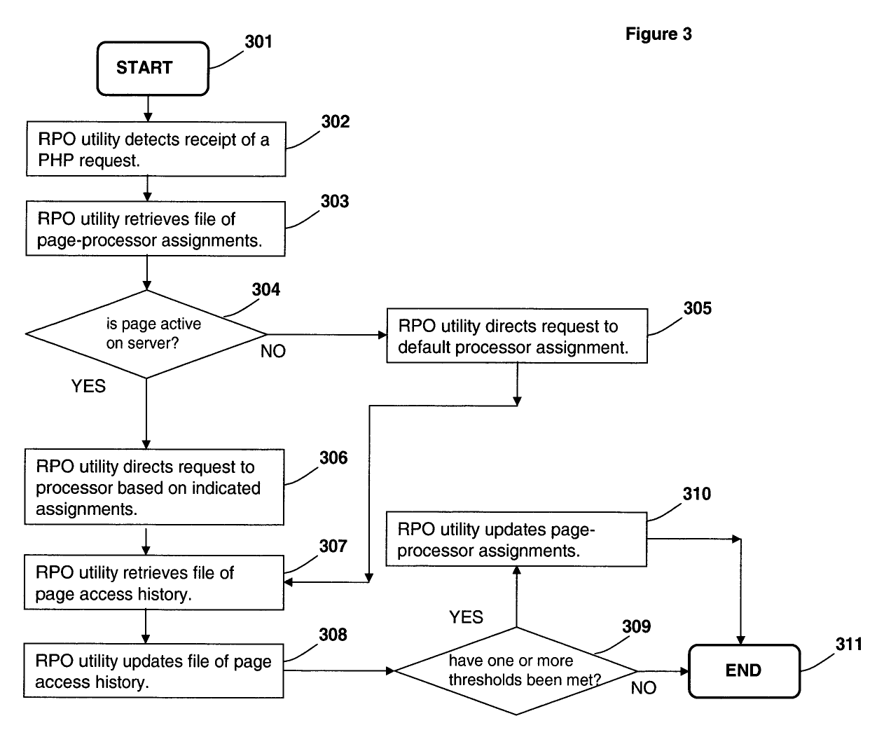

CPU1 101 and CPU2 105 executes RPO utility 110 as well as OS 108. Among the software code/instructions provided by RPO utility 110, and which are specific to the invention, are: (a) code for identifying the PHP pages which are active on a server; (b) code for evaluating a number of conditions to determine whether a new processor assignment is desired; and (c) code for assigning a page request to a particular processor on the server. For simplicity of the description, the collective body of code that enables these various features is referred to herein as RPO utility 110. According to the illustrative embodiment, when CPU1 101 or CPU2 105 executes RPO utility 110, DPS 100 initiates a series of functional processes that enable the above functional features as well as additional features/functionality, which are described below within the description of FIGS. 2-3.

Those of ordinary skill in the art will appreciate that the hardware and basic configuration depicted in FIG. 1 may vary. For example, other devices/components may be used in addition to or in place of the hardware depicted. The depicted example is not meant to imply architectural limitations with respect to the present invention. The data processing system depicted in FIG. 1 may be, for example, an IBM eServer pSeries system, a product of International Business Machines Corporation in Armonk, N.Y., running the Advanced Interactive Executive (AIX) operating system or LINUX operating system.

With reference now to FIG. 2, a network is illustrated, in which a client's request for dynamic content received by an application server that processes the requests, according to an illustrative embodiment. Network 200 comprises client 1 133 and client 2 202 which both connect to network (infrastructure) A 203. Client 1 133 comprises browser 112. Also connected to network A 203 is application server 100. Application server 100 comprises CPU1 101 and CPU2 105. Illustrated within server 100 are a number of software/firmware components, including RPO utility 110, PHP runtime 111, page-processor assignment files 114 and access history 109.

In network 200, client 1 133 makes a request for PHP pages via browser 112. The requests for PHP pages are received by server 100 via network 203. RPO utility 110 determines whether the requested PHP page(s) are active on server 100 and forwards requests for specific pages to a processor (CPU1 101 or CPU2 105) which has recently processed that page. A request processing optimization (RPO) utility assigns an initial request received at the server for a PHP page based on a number of factors which may include a relative usage level of a processor within a pool of available processors on a server. Additional processors may be assigned to specific pages based on: (1) a threshold frequency of page requests; and (2) a resource intensive factor of a page request measured by average response time of the page request. Processing of the requested pages by assigned processors is facilitated by associated caches containing a requisite set of code to construct the requested page(s). The flow chart of FIG. 3 provides a further description of the process of identifying PHP pages which are active on a server and assigning requests for specific PHP pages to one or more processors.

FIG. 3 is a flow chart illustrating a method by which the above processes of the illustrative embodiments are completed. Although the methods illustrated in FIG. 3 may be described with reference to components shown in FIGS. 1-2, it should be understood that this is merely for convenience and alternative components and/or configurations thereof can be employed when implementing the various methods. Key portions of the methods may be completed by RPO utility 110 executing within DPS 100 (FIG. 1) and controlling specific operations of/on DPS 100, and the methods are thus described from the perspective of either/both RPO utility 110 and DPS 100.

The process of FIG. 3 begins at initiator block 301 and proceeds to block 302, at which RPO utility 110 detects the receipt of a PHP page request at the PHP runtime. At block 303, RPO utility 110 retrieves a file of “page-processor” assignments, i.e., a file indicating which PHP page codes are stored in specific processor caches. At decision block 304, RPO utility 110 determines whether the requested page is active on the server and has a previous processor assignment. If at block 304, RPO utility 110 determines that the requested page does have a processor assignment, the process proceeds to block 306, at which RPO utility 110 directs the page request to an assigned processor. RPO utility 110 retrieves file of page access history, as shown at block 307. If at block 304, RPO utility 110 determines that the requested page does not have a processor assignment, the process proceeds to block 305, at which RPO utility 110 directs the page request to a processor based one or more of the following assignment factors: (1) a processor which is characterized by a low processor usage; and (2) a processor which is identified based upon a default listing of processor assignments. Following block 305, the process proceeds to block 307. At block 308, RPO utility updates the file of page access history based on the most recent page request.

RPO utility 110 may assign a processor to specific page requests based on a number of factors which include one or more of the following: (1) a threshold number of previous and/or contending page requests; (2) a threshold frequency of page requests; and (3) a resource intensive factor (threshold value) of a requested page. RPO utility 110 may evaluate the resource intensive factor of a requested page based on an average of the response time of the page request. Consequently, a page may be assigned to more than one processor within the pool of processors. Thus, RPO utility 110 determines whether one or more of the above thresholds have been met, as shown at decision block 309. If at block 309, RPO utility 110 determines that one or more thresholds have been met, the process proceeds to block 310, at which RPO utility 110 updates the page-processor assignments. If at block 309, RPO utility 110 determines that no thresholds have been met, the process ends at block 311.

In the flow charts above, one or more of the methods are embodied as a computer program product in a computer readable medium or containing computer readable code such that a series of steps are performed when the computer readable code is executed on a computing device. In some implementations, certain steps of the methods are combined, performed simultaneously or in a different order, or perhaps omitted, without deviating from the spirit and scope of the invention. Thus, while the method steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

As will be further appreciated, the processes in embodiments of the present invention may be implemented using any combination of software, firmware or hardware. As a preparatory step to practicing the invention in software, the programming code (whether software or firmware) will typically be stored in one or more machine readable storage mediums such as fixed (hard) drives, diskettes, optical disks, magnetic tape, semiconductor memories such as ROMs, PROMs, etc., thereby making an article of manufacture (or computer program product) in accordance with the invention. The article of manufacture containing the programming code is used by either executing the code directly from the storage device, by copying the code from the storage device into another storage device such as a hard disk, RAM, etc., or by transmitting the code for remote execution using transmission type media such as digital and analog communication links. The methods of the invention may be practiced by combining one or more machine-readable storage devices containing the code according to the present invention with appropriate processing hardware to execute the code contained therein. An apparatus for practicing the invention could be one or more processing devices and storage systems containing or having network access to program(s) coded in accordance with the invention.

Thus, it is important that while an illustrative embodiment of the present invention is described in the context of a fully functional computer (server) system with installed (or executed) software, those skilled in the art will appreciate that the software aspects of an illustrative embodiment of the present invention are capable of being distributed as a computer program product in a variety of forms, and that an illustrative embodiment of the present invention applies equally regardless of the particular type of media used to actually carry out the distribution. By way of example, a non exclusive list of types of media, includes recordable type (tangible) media such as floppy disks, thumb drives, hard disk drives, CD ROMs, DVDs, and transmission type media such as digital and analogue communication links.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. In a server system having multiple processors, a method comprising:
detecting a receipt of a Hypertext Preprocessor (PHP) page request at the PHP runtime of the server;
determining when a requested PHP page represents one of:
(1) an initial request received at the server for a particular page; and
(2) a request for a previously processed page at the server;
assigning the PHP page request to one or more processors, wherein the one or more processors have associated caches wherein said associated caches contain a requisite set of code to construct the requested page; and
forwarding the request to a particular processor within a pool of available processors on the server.

2. The method of claim 1, wherein said determining further comprises:
retrieving the file of the history of page requests;
identifying a number of times a request for a particular page is received;
updating the file of the history of page requests; and
storing an updated file of the history of page requests.

3. The method of claim 1, wherein said assigning further comprises:
when an initial page request is received, selecting a processor based on one or more of the following initial assignment factors:
(1) a low processor usage; and
(2) a list pertaining to a default methodology of processor assignments;
triggering a new page-processor assignment, based on one or more of: the initial assignment factors; and a fulfillment of one or more of a number of conditions pertaining to page requests;
when the new page-processor assignment is triggered or the initial request is assigned to the processor:
(1) retrieving the file of page-processor assignments; and
(2) updating the file of page-processor assignments.

4. The method of claim 3:
wherein said conditions include one or more of:
(1) a threshold number of previous page requests;
(2) a threshold number of current contending page requests;
(3) a threshold frequency rate of incoming page requests; and
(4) a threshold value of a resource intensive factor of a requested page, wherein said resource intensive factor of the requested page is based on a number of factors including an average of the response time of the page request.

5. A data processing system comprising:
a group of processors which execute a set of PHP page code;
a memory system which stores a PHP runtime system;
a network connection;
a utility which when executed within one or more of the group of processors provides functions for:
detecting a receipt of a Hypertext Preprocessor (PHP) page request at the PHP runtime of the server;
determining when a requested PHP page represents one of:
(1) an initial request received at the server for a particular page; and
(2) a request for a previously processed page at the server;
assigning the PHP page request to one or more processors, wherein the one or more processors have associated caches wherein said associated caches contain a requisite set of code to construct the requested page; and
forwarding the request to a particular processor within a pool of available processors on the server.

6. The system of claim 5, wherein said determining further comprises:
retrieving the file of the history of page requests;
identifying a number of times a request for a particular page is received; and
updating the file of the history of page requests; and
storing an updated file of the history of page requests.

7. The system of claim 5, wherein said assigning further comprises:
when an initial page request is received, selecting a processor based on one or more of the following initial assignment factors:
(1) a low processor usage; and
(2) a list pertaining to a default methodology of processor assignments;
triggering a new page-processor assignment, based on one or more of: the initial assignment factors; and a fulfillment of one or more of a number of conditions pertaining to page requests;
when the new page-processor assignment is triggered or the initial request is assigned to the processor:
(1) retrieving the file of page-processor assignments; and
(2) updating the file of page-processor assignments.

8. The system of claim 7:
wherein said conditions include attaining one or more of:
(1) a threshold number of previous page requests;
(2) a threshold number of current contending page requests;
(3) a threshold frequency rate of incoming page requests; and
(4) a threshold value of a resource intensive factor of a requested page, wherein said resource intensive factor of the requested page is based on a number of factors including an average of the response time of the page request.

9. A computer program product comprising:
a computer readable medium; and
program code on said computer readable medium that when executed within a data communication device, said program code provides the functionality of:
detecting a receipt of a Hypertext Preprocessor (PHP) page request at the PHP runtime of the server;
determining when a requested PHP page represents one of:
(1) an initial request received at the server for a particular page; and
(2) a request for a previously processed page at the server;
assigning the PHP page request to one or more processors, wherein the one or more processors have associated caches wherein said associated caches contain a requisite set of code to construct the requested page; and
forwarding the request to a particular processor within a pool of available processors on the server.

10. The computer program product of claim 9, wherein said code for determining further comprises code for:
retrieving the file of the history of page requests;
identifying a number of times a request for a particular page is received; and
updating the file of the history of page requests; and
storing an updated file of the history of page requests.

11. The computer program product of claim 9, wherein said code for assigning further comprises code for:
when an initial page request is received, selecting a processor based on one or more of the following initial assignment factors:
(1) a low processor usage; and
(2) a list pertaining to a default methodology of processor assignments;
triggering a new page-processor assignment, based on one or more of: the initial assignment factors; and a fulfillment of one or more of a number of conditions pertaining to page requests;
when the new page-processor assignment is triggered or the initial request is assigned to the processor:
(1) retrieving the file of page-processor assignments; and
(2) updating the file of page-processor assignments.

12. The computer program product of claim 11:
wherein said conditions include one or more of:
(1) a threshold number of previous page requests;
(2) a threshold number of current contending page requests;
(3) a threshold frequency rate of incoming page requests; and
(4) a threshold value of a resource intensive factor of a requested page, wherein said resource intensive factor of the requested page is based on a number of factors including an average of the response time of the page request.
